(19) United States
(12) Patent Application Publication
(10) Pub. No.: US 2014/0058881 A1
(43) Pub. Date: Feb. 27, 2014

(54) System and Process for Crop Scouting and Pest Cure Recommendation

(71) Applicant: Frank A Rosenbaum, Oro Valley, AZ (US)

(72) Inventor: Frank A Rosenbaum, Oro Valley, AZ (US)

(73) Assignee: NEUCADIA, LLC, Carson City, MI (US)

(21) Appl. No.: 13/834,264

(22) Filed: Mar. 15, 2013

Related U.S. Application Data
(60) Provisional application No. 61/692,774, filed on Aug. 24, 2012.

(51) Int. Cl. G06Q 50/02; G06Q 30/06

(52) U.S. Cl. CPC G06Q 50/02; G06Q 30/0631
USPC 705/26.7

(57) ABSTRACT

A process and system implemented on a portable computing device, which is equipped with a global positioning system, for crop scouting and pest cure recommendation. The process or system provides Farm Scout, Agronomist and Sales Personnel with an ability to: (1) easily identify and mark the geo-location of insects, weeds, diseases or other remarkable conditions; (2) report findings to customers in a concise format; (3) provide product and application recommendations to customers for curing remarkable conditions; and (4) maintain easily accessible history files used to determine trends and successful treatment programs.

### CROSS-REFERENCE TO RELATED APPLICATION

This application claims priority from U.S. Provisional Patent Application Ser. No. 61/692,774, filed Aug. 24, 2012. The entire contents of the aforementioned application are incorporated herein by reference.

### BACKGROUND

This disclosure relates to a process and system implemented on a portable computing device for crop scouting and pest cure recommendation in agribusiness.

Crop scouting is regular and precise assessments of field condition (e.g., pest or insect pressure, weeds, and diseases) and crop performance to evaluate economic risk from pest infestation and disease, and the potential effectiveness of pest and disease control intervention. It is an economically and environmentally sound prerequisite to pest management and field operation. In agricultural business, scouting is usually sold as a commercial service to farmer customers.

Current crop scouting and pest cure recommendation systems mostly fail to provide a completely integrated, fully portable, synchronized internet and native computer system capable of maintaining a database of customers, farms and farm field geospatial data for Farm Scouting.

### SUMMARY

The present disclosure provides a system and process implemented on a portable computing device, which is equipped with a global positioning system, for crop scouting and pest cure recommendation. In particular, the disclosed process and/or system provides Farm Scout, Agronomist and Sales Personnel with an ability to: (1) easily identify and mark the geo-location of insects, weeds, diseases or other remarkable conditions; (2) report findings to customers in a concise format; (3) provide product and application recommendations to customers for curing remarkable conditions; and (4) maintain easily accessible history files used to determine trends and successful treatment programs.

In some embodiments, the disclosed process or system contains a serious of software programs that are loaded and operate independently on a global positioning system (“GPS”) capable computing device, which includes but is not limited a computer, a notebook, a tablet, and a cell phone.

For example, the term “computing device” herein can represent one of the following computer hardware: Macintosh, a computer made by Apple, Inc. including desktop, laptop and notebook models; iPad, a notebook style, touch screen computer made by Apple, Inc. capable of Internet access, text messaging, e-mail, Web browsing, still and video camera and touch screen capability; Smartphone, a broad category of cellular telephones capable of Internet access, text messaging, e-mail, Web browsing, still and video camera and touch screen capability; iPhone, a category of Smartphone manufactured by Apple, Inc. capable of Internet access, text messaging, e-mail, Web browsing, still and video camera and touch screen capability; any other IOS system based computer processor; PC, a broad category of Windows-based computers including desktop, laptop and notebook models; Android based computer devices; and, any other computer system not mentioned herein. In a preferred embodiment, the computing device is fully portable.

As used herein, the term “or” is meant to include both “and” and “or.” In other words, the term “or” may also be replaced with “and/or.”

In some embodiments, the disclosed system or process will operate on any binary coded digit or other operating system. The system or process can be both Internet based and native application based if it is executed on a portable computing device equipped with a network card. For example, the Internet based application is the primary system operational software. When an Internet/Wireless signal is lost, the native based application continues to operate in a mode that is transparent to the user. While running under the native application, the software stores captured data in a temporary cache file. When Internet service is restored, the internet based system interrogates the cache file to update the Internet based system files. This process allows the system to be operated in rural areas that have limited wireless Internet service.

In some embodiments, the disclosed process contains one or more of the following steps; the disclosed system has one or more of the following contributions.

The system or process can provide a “user” (or interchangeably an “operator”) with the ability to locate, display and save a geospatial system map that includes farm field physical boundaries as a polynomial expression, through the use of either a touch screen computer or non-touch screen computer employing a keyboard or mouse.

The system or process can provide the user with the ability to import computer shape files of farm field physical boundaries from computer based systems where the farm field physical boundaries were previously determined and saved as shape files.

The system or process can provide the system user with the ability to mark the entrance(s) to the farm field.

The system or process can provide turn-by-turn directions and a detailed route map, in either roadmap or satellite view, from the user's present position to the entrance of the farm field.

The system or process can provide the user with a method to identify insects, weeds, diseases or other remarkable conditions by providing the system user with a reference library of both definitions and photographs of insects, weeds, diseases or other remarkable conditions used for comparative identification of conditions noted.

The system or process can provide the user with a method to geo-locate dropped pins and note the condition severity where insects, weeds, diseases or other remarkable conditions are found within the geospatial boundaries of the farm field.

The system or process can provide the user with a method to specifically identify the condition noted and severity where pins are dropped within the geo-fence boundaries of the farm field by utilizing the same colors for pins and conditions noted and also consecutively numbering dropped pins and listing the numerically referenced corresponding description of findings in a separate frame on the computer screen.

In some embodiments, the computing device includes a camera. Accordingly, the disclosed system or process provides the user with a method to take either a digital photograph or digital video of a remarkable condition within the geo-fence boundaries of the farm field and associate the digital photo or video with a dropped pin in order to memorialize the noted condition.

Additionally, the system or processor can provide the user with a method to edit and report the following information previously saved to a computer file by customer, farm and farm field: (1) the geospatial boundaries of the farm field, (2) the entrance(s) to the farm field, (3) the remarkable conditions noted by geo-located pins, (4) the severity of the condition, (5) the description of the remarkable conditions of corresponding geo-located pins, and (6) the photograph and/or video of the remarkable conditions of corresponding geo-located pins.

The disclosed system or process can provide the user with a method to report the following information previously saved to computer files in any order of the customer, the farm, farm field, the noted condition (e.g., weed, insect, disease, and other remarkable conditions), severity of the condition, and defined geospatial area: (1) the geospatial boundaries of the farm field, (2) the entrance(s) to the farm field, (3) the remarkable conditions noted by geo-located pins, (4) the severity of the condition, (5) the description of the remarkable conditions of corresponding geo-located pins, (6) the photograph and/or video of the remarkable conditions of corresponding geo-located pins and (7) recommendations for curing the remarkable conditions noted by the geo-located pins. The report medium will utilize, but is not be limited to, email, text, facsimile, telephone, voice mail, various forms of social media, push notifications and printed hard copy to communicate findings and recommendations to customers.

The disclosed system or process further can provide the user with a method to maintain a complete history file of (1) the conditions noted during scouting activities of the farm field, (2) recommended treatment of remarkable conditions, and (3) the effectiveness of recommended treatments. The history file is useful for identifying trends and determining optimal products and application rates and methods that successfully cure remarkable conditions.

Still, the disclosed system or process can provide the user with the ability to access the customer, farm and farm field information automatically when the system user is within a pre-specified range or distance from the farm field. Data access is through a pre-loaded GPS capable Smartphone, iPhone, iPad, Macintosh, PC or other device application.

In some embodiments, the present disclosure relates to a system including a geo-location module for identifying and making geo-location of insects, weeds, diseases, or other remarkable conditions; a reporting module for reporting findings to a customer; a recommendation module for providing product and application recommendations to the customer; and a history module for maintaining a history file to determine trends and treatment programs. The system is implemented on a portable computing device equipped with a global positioning system module, and is capable of interacting with the global positioning system module.

In some other embodiments, the above-mentioned system also includes a graphic user interface (“GUI”), which allows a user to enter data, command, selection, or response into the system by a user input device, and review output information by a display device. The user input device may include a touch screen, a keyboard, or a mouse. The display device may include a screen or a printer. The system can be connected to a camera, and thus is capable of taking and receiving a digital photograph or digital video of a remarkable condition.

In some embodiments, the above-mentioned geo-location module includes means to locate, save, and transfer to the display device a geospatial system map that includes physical boundaries of the farm field as a polynomial expression, through the user input device; means to import computer shapefiles of physical boundaries of the farm field from computer based systems, wherein the physical boundaries were previously determined and saved as shape files; means to mark an entrances to the farm field by the user; means to provide turn-by-turn directions and a route map in a roadmap or satellite view; means to automatically access the data of a customer, farm, or field, when a user is within a pre-specified distance from the field; means to identifying insects, weeds, diseases or other remarkable conditions by providing a user with a reference library of definitions and/or photographs of insects, weeds, diseases or other remarkable conditions; means for dropping a pin and noting the condition or severity on the map showing the place of insects, weeds, diseases, or other remarkable conditions; or means to color and number the dropped pin for further identifying the noted condition or severity.

The geo-location module may further include means to take a digital photograph or digital video associate the photograph or video with a dropped pin; means to download the digital photograph taken by the camera, compare the digital photograph to a file of known agricultural pests or weeds; and select a known agricultural pest or weed that exemplifies the characteristics of the digital photograph.

The reporting module may include means to create, edit, or save a report from previously saved information by the graphic user interface, wherein the report includes: geospatial boundaries of a farm field; an entrance to the farm field, a noted remarkable condition associated with a dropped pin, the severity of the condition, a description of condition associated with a dropped pin, a photograph or video associated with a dropped pin, or a recommendation for curing the remarkable condition.

Still in some embodiments, the recommendation module may include means to create, edit, or save recommendations for curing the remarkable condition. The history module may include means to maintain a complete history file for a noted condition by crop scouting, a recommended treatment of the condition, and effectiveness of the recommended treatment

In sum, the present disclosed process and system provide the agribusiness user with a complete, portable, fully integrated computer solution for (1) agribusiness recordkeeping related to farm field remarkable conditions and/or farm field recommendations for curing conditions; (2) customer notification of farm field remarkable conditions and/or farm field recommendations for curing conditions; (3) booking or completing customer work order; and/or (4) for automatically preparing and sending customer invoices at the completion of customer work orders.

In some embodiments, the present disclosure also relates to a process and system that provides a complete history file of farm field remarkable conditions and recommended cures which is available for review and analysis, or a geospatial process for the unique identification of customer, farm, and farm field information and provides for data capture and reporting of information contained within the boundaries of the geo-location.

### BRIEF DESCRIPTION OF THE DRAWINGS

The above-mentioned and other features of this disclosure and the manner of obtaining them will become more apparent, and the disclosure itself will be best understood by reference to the following descriptions of systems and methods taken in conjunction with the accompanying figures, which are given as non-limiting examples only, in which:

FIG. 1 shows a flowchart of System Overview according to the present disclosure;

FIG. 2 shows a flowchart of System Operation implemented on iPad/iPhone/Macintosh;

FIG. 3 shows a flowchart of System Operation implemented on PC/Smartphone;

FIG. 4 is an exemplary screenshot for the GUI of the present system showing the main navigation menu or “Home Page” view;

FIG. 5 is an exemplary screenshot for the GUI showing the “Add Customer Home Page” view;

FIG. 6 is an exemplary screenshot for the GUI showing the “Add Customer Page” view;

FIG. 7 is an exemplary screenshot for the GUI showing the “Add Farm Page” view;

FIG. 8 is an exemplary screenshot for the GUI showing the “Add Field Page” view;

FIG. 9 is an exemplary screenshot for the GUI showing the “Draw Field Page” view;

FIG. 10 is an exemplary screenshot for the GUI showing the “Schedule Scout Page” view;

FIG. 11 is an exemplary screenshot for the GUI showing the “Scout Now Page” view;

FIG. 12 is an exemplary screenshot for the GUI showing the “Directions Page” view;

FIG. 13 is an exemplary screenshot for the GUI showing the “Scout Field Page” view;

FIG. 14 is an exemplary screenshot for the GUI showing the “Add Issue Page” view;

FIG. 15 is an exemplary screenshot for the GUI showing the “Scouting Drop Pin Page” view;

FIG. 16 is an exemplary screenshot for the GUI showing the “Product Recommendation Input Screen” view;

FIG. 17 is an exemplary screenshot for the GUI showing the “Recommendation Email to Customer Page” view;

FIG. 18 is an exemplary screenshot for the GUI showing the “Scouting Help and Information” view;

FIG. 19 is an exemplary screenshot for the GUI showing the “Settings” view; and

FIG. 20 is an exemplary screenshot for the GUI showing the “Report” view.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiments in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or illustrated in the figures.

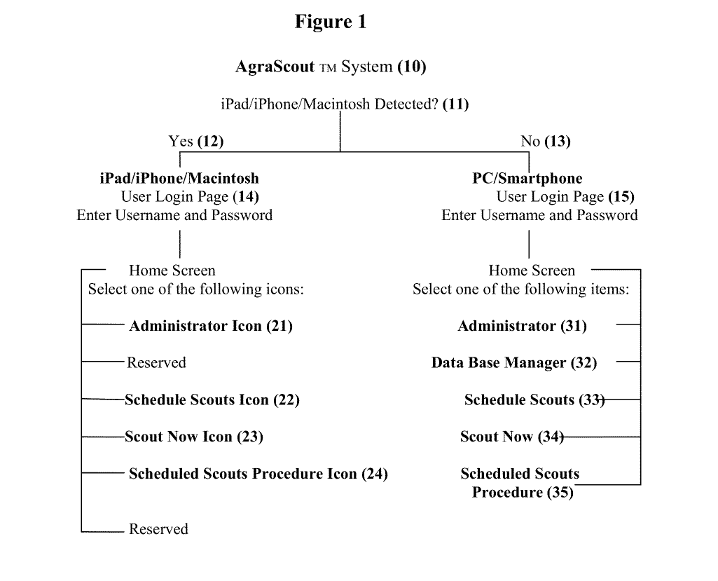

As shown in FIGS. 1-3, an example system 10 (e.g., “AgraScout™ System”) according to the present disclosure can be operated on GPS capable iPad/iPhone/Macintosh, PC/Smartphone, or other binary digit or other operating systems. Examples and definitions of Macintosh, iPad, Smartphone, iPhone have been disclosed above. The system 10 begins with an automatic iPad/iPhone/Macintosh detection (process 11) in order to choose between the two system operation, both requiring a user to login by entering their username and password (process 14 or 15). If iPad/iPhone/Macintosh is detected, the iPad/iPhone/Macintosh system operation will automatically run (process 12). Otherwise, the PC/Smartphone operation begins to run (process 13).

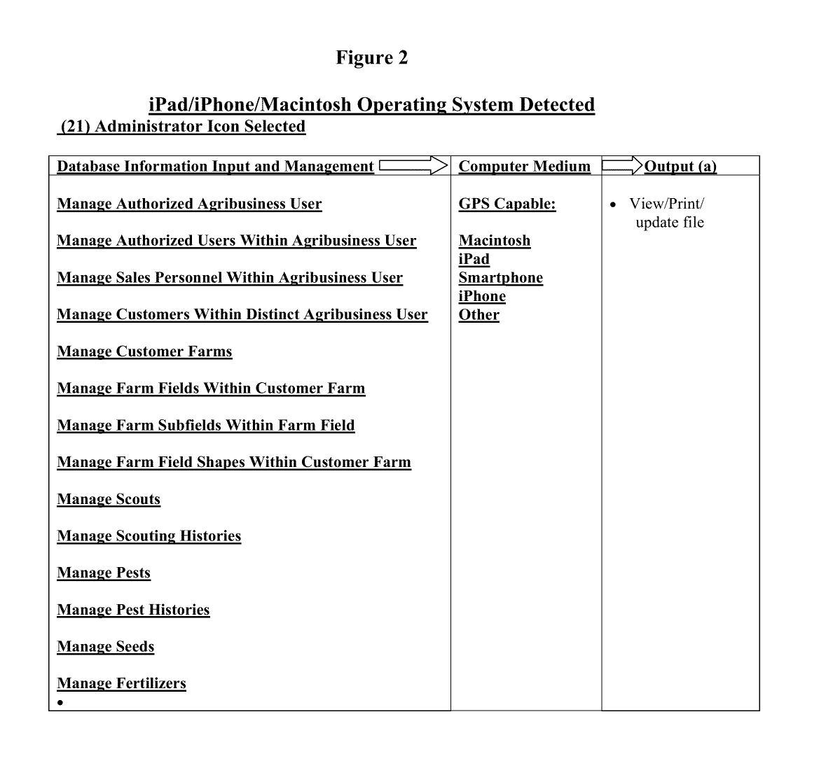

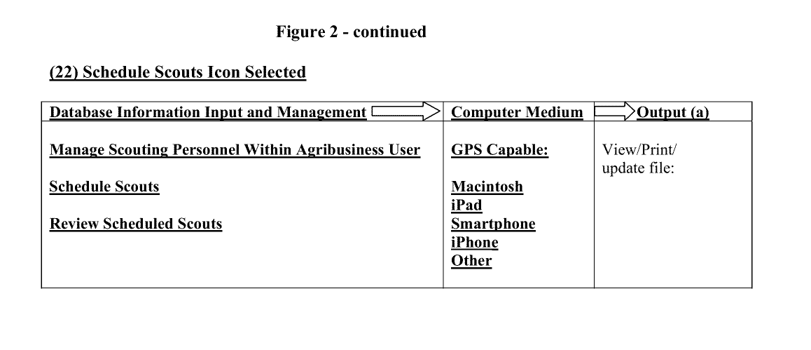

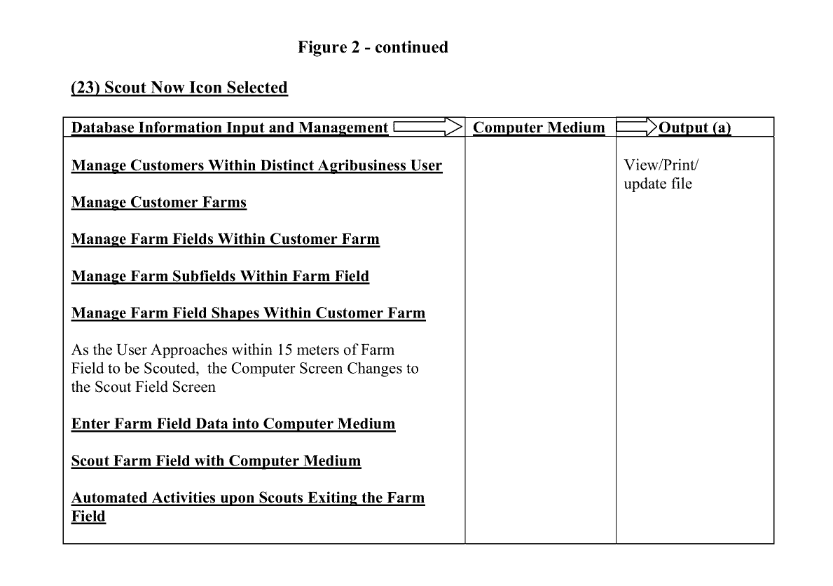

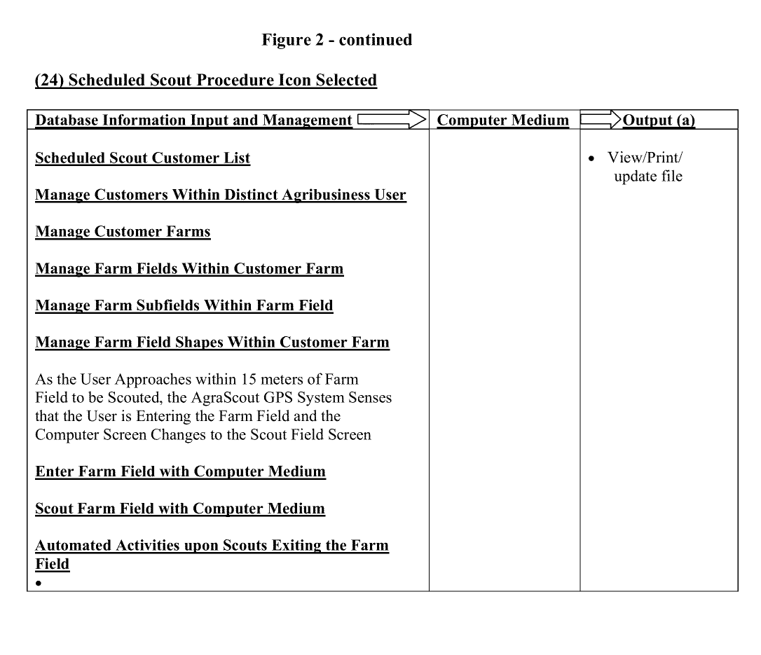

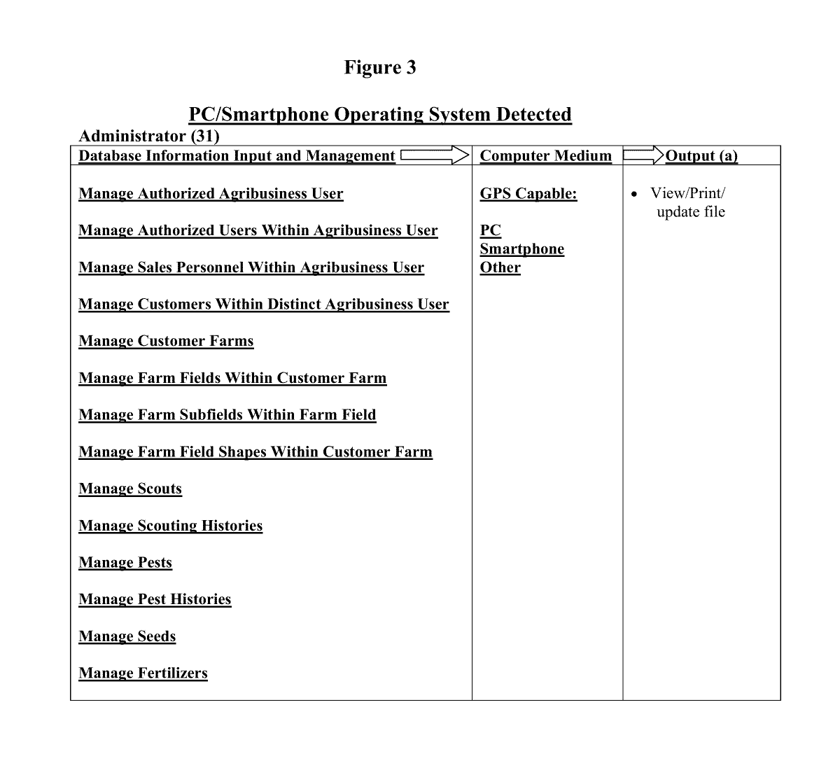

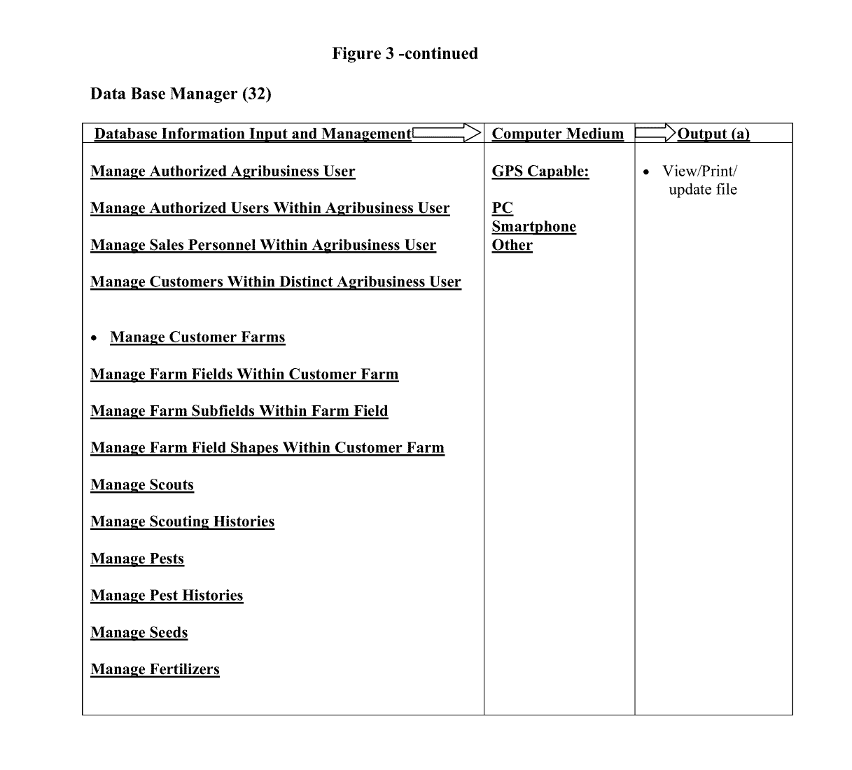

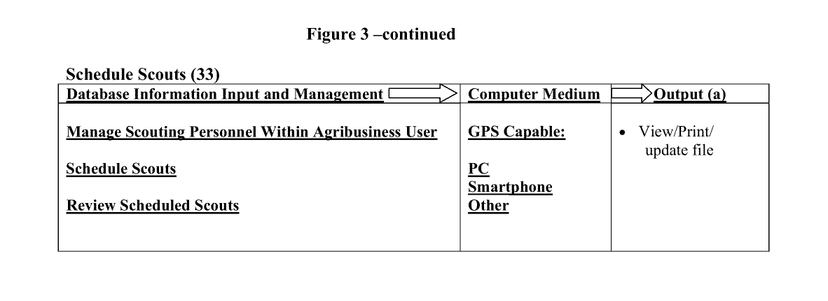

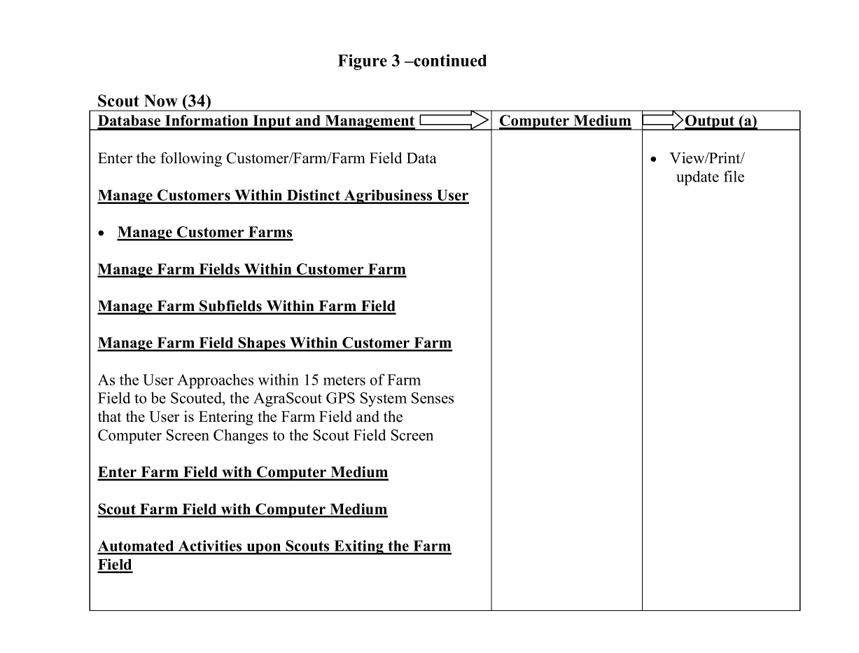

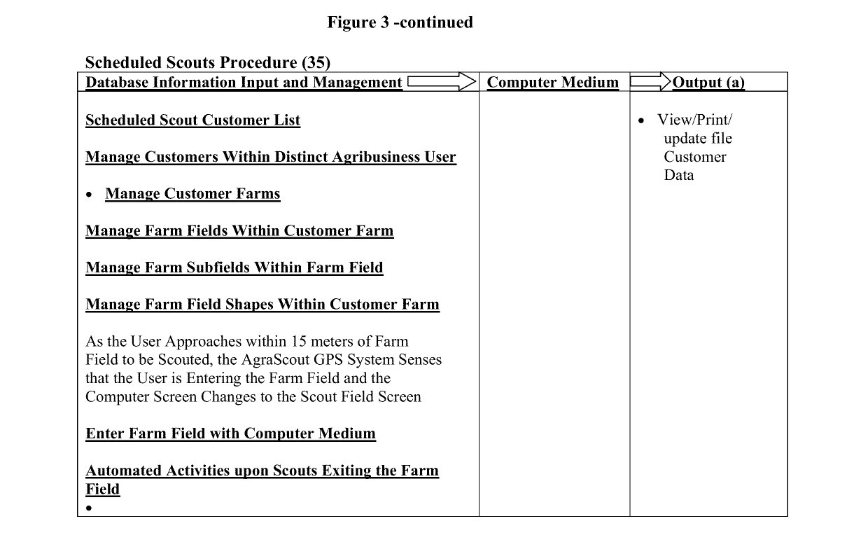

Both iPad/iPhone/Macintosh operation and PC/Smartphone operation provide users with similar interactions and functions. Both operations, as shown in FIGS. 2-3, contain in general three steps: (1) database information input and management; (2) data storage and operation by a computer or computing medium; and (3) data output.

For data base input and management, as shown in FIGS. 2-3, the user can select “Administrator Icon” 21 for iPad/iPhone/Macintosh operation, or “Administrator” 31/“Data Base Manager” 32 for PC/Smartphone operation, from a navigation menu, and then Manage Authorized Agribusiness User data (e.g., name, address, telephone number, customer number, geospatial data, username and password); Manage Authorized Users Within Agribusiness User data (e.g., their name, username, and password); Manage Sales Personnel Within Agribusiness User data (e.g., their name); Manage Customers Within Distinct Agribusiness User data (e.g., their name, address, telephone number, customer number, and geospatial data); Manage Customer Farms data (e.g., their name, address, telephone, number, geospatial data), Manage Farm Fields Within Customer Farm data (e.g., their name); Manage Farm Subfields Within Farm Field data (e.g., their name); Manage Farm Field Shapes Within Customer Farm data (e.g., their geospatial data); Manage Scouts data (e.g., name); Manage Scouting Histories data; Manage Pests data; Manage Pest Histories data; Manage Seeds data; or Manage Fertilizers data,. As used herein, the term “Manage” is meant to include “add, edit, and/or delete.”

Alternatively, the user can select “Schedule Scouts Icon” 22 for iPad/iPhone/Macintosh operation, or “Schedule Scouts” 33 for PC/Smartphone operation, and then Manage scouting personnel within agribusiness user data (e.g., name), schedule scouts (e.g., by selecting personnel, customer, farm, field, or date); or review scheduled scouts by order of scout, date, customer, and/or geospatial area (e.g., by Scout, Date and Customer, by Customer, Date and Scout; by Date, Scout and Customer; by Date, Customer and Scout; by Geo-spatial area, Date, Scout and Customer; by Geo-spatial area, Scout, Date and Customer; by Geo-spatial area, Customer, Date and Scout; by Geo-spatial area, Customer, Scout and Date).

The user can also select “Scouts Now Icon” 23 for iPad/iPhone/Macintosh operation, or “Schedule Now” 34 for PC/Smartphone operation, and then enter and/or Manage customers, customer farms, farm fields, farm subfields, farm field shapes, as described above. As such, when the user approaches within fifteen meters of the chosen field, the system receives GPS signals from the GPS module and is capable of automatically displaying and changing to a Scout Field screen.

The system then provides the user with means to enter Farm Field data into computer medium. For example, the user enters crop type and maturity in left hand column portion of the Scout Field Screen. This column also includes icons for the type of issues that may be noted during scouting activity. The center of the Scout Field Screen is a map indicating the Farm Field Boundaries. User can also mark entrance to farm field by clicking or touching the “Mark Farm Field Entrance” icon so that such an icon appears on screen. The user touches or clicks and drags Farm Field Entrance icon to farm field entrance location.

The system can also provide the user with means to scout Farm Field with computer medium. For example, the user marks weed, insect, disease or other conditions noted as Farm Field is scouted by touching the Weed, Insect, Disease or Other Condition Icon on the screen. The system provides a listing of pests under each Weed, Insect, Disease or Other Condition Icon. The user then can select pest from drop down list which brings up a picture of the pest on the screen to help the scout verify the pest. If incorrect pest is shown on screen, user selects another pest and a corresponding picture is shown on the screen. Further, the user can tap on screen to verify the correct pest is indicated, and/or indicates the severity of the weed, insect, disease or other condition by touching the Severity Icon and touching the severity levels provided in the drop down box. Depending upon which type of issue is selected, a consecutively numbered Weed, Insect, Disease or Other Condition Icon appears on the screen. User touches and drags Farm Field Weed, Insect, Disease or Other Condition Icon to location in the farm field where the condition is found. A consecutive list of issues noted in the farm field that corresponds to the icons dropped in the farm field is maintained for user reference in a column in the right hand portion of the screen. User may take a photograph or video of remarkable condition and attach to any dropped pin/icon.

Further, the system can conduct automated activities when scouts exist in the field. For example, When the system senses that the scout's computer/computing device is 15 meters away from the farm field and the computer is moving in a direction away from the farm field, a scouting results email is generated that indicates, customer, farm, farm field, farm field size in acres, crop type, maturity, a reproduction of the farm field map with boundaries and consecutively numbered icons representing the issues noted during scouting activity and a consecutively numbered detailed written description of issues noted while scouting the farm field. The scouting results email is sent to the system user who scouted the farm field and. The scouting results email is then edited by the as required to make corrections to scouting results. The scouting results email includes a section for the sales person responsible for the customer to make recommendations to cure the findings noted during the scouting process. The sales person lists products and quantities required to cure farm field issues. The sales person sends the scouting results email to the customer. The scouting activity and scouting results email are maintained in a scouting history file. upon notification of customer acceptance of the recommendations to cure farm field issues, a customer work order is generated by the system that includes all of the detail included in the scouting results email plus an interactive map of the farm field scouting results and directions from the users present position to the farm field entrance in map route format and turn-by-turn driving directions. Upon the completion of the customer work order, customer invoice is generated and automatically sent to customer.

In addition, the user can select “Scheduled Scout Procedure Icon” 24 for iPad/iPhone/Macintosh operation, or “Scheduled Scout Procedure” 35 for PC/Smartphone operation, and then under Scheduled Scout Customer List, view customer name, farm and farm fields scheduled to be scouted by user; or tapping on any of the items in the list brings up a route map and turn-by-turn directions to the farm field. Note that scheduled scouts utilize customer data entered and maintained in section Administration, so that the scouts have the ability to make necessary changes to the customer data to maintain up-to-date information. The user can Manage Customers Within Distinct Agribusiness User data; Manage Customer Farms data; Manage Farm Fields Within Customer Farm data; Manage Farm Subfields Within Farm Field; Manage Farm Field Shapes Within Customer Farm.

Further, as the user approaches within fifteen meters of farm field to be scouted, the GPS system senses that the user is entering the farm field and the computer screen changes to the Scout Field Screen. Again, user can enter farm field with computer medium and scout farm field with computer medium, while system will conduct automated activities upon scouts existing the farm files, as described before.

Through data output, the system provides the user means to view, print, email, or to update a data, file, or information, including scouting results email, customer work order, and customer invoice (e.g., Authorized Agribusiness User Data; Sales Personnel Names; Customer Data; Farm Data; Farm Field Name; Farm Subfield Name; Farm Field Shape; Scout Name; History; Pest; Pest History; Seed; Fertilizer Scouting Personnel Names; Scout Schedule; Scheduled Customer Data; Farm Data; Farm Field Name; Farm Subfield Name; Farm Field Shape; Farm Field Shape and Farm Field Entrance Icon; Dropped Weed, Insect, Disease or Other Condition Icons; List of Issues; Scouting Results Email; Customer Work Order; Customer Invoice).

The system output is sorted by user determined fields maintained in the database. All database fields are available to the user for output sorting. In addition, geo-spatial data is available for sorting by user defined geo-spatial coordinates and other parameters such as zip codes, city, county, state or region.

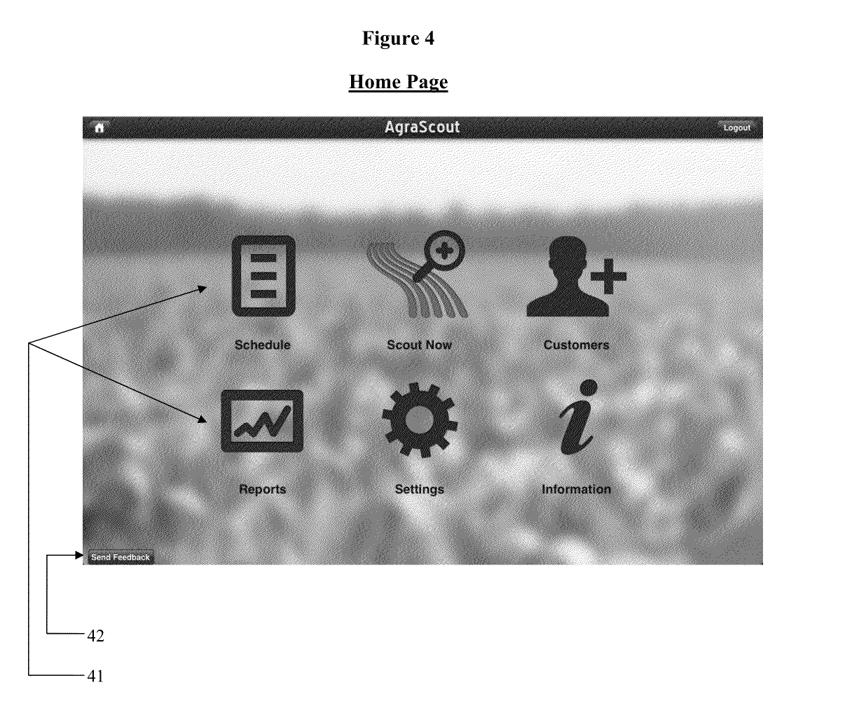

FIGS. 4-20 show a series of exemplary screenshots for the GUI of the present system. In specific, FIG. 4 shows a main navigation menu or “Home Page” view. There are five main icons 41—i.e., Schedule, Scout Now, Customers, Reports, Settings, Information—displayed on the screen. The user can select any of the icons in order to begin the farm field scouting process according to present disclosure. In addition, a small “Send Feedback” icon 42 is shown at the left bottom corner, which allows users to submit errors or submit help questions to administrator.

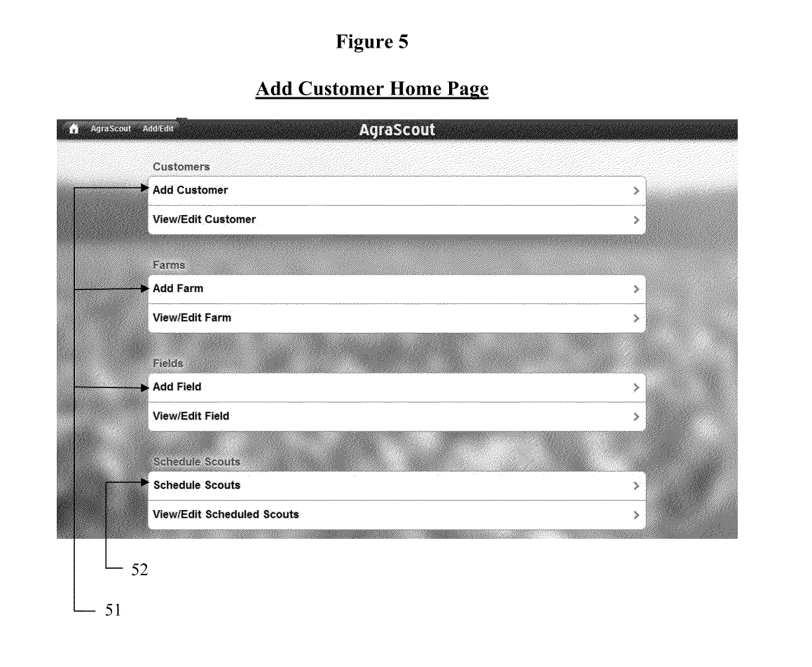

FIG. 5 shows an example screenshot of the “Add Customer Home Page” view. The system permits users, by selecting a selection bar 51, to add, view, or edit customers/farms/fields or selecting bar 52 to schedule, view, or edit scouts. Particularly, the user can import customer data automatically from shapefiles; manually add customers/farms/fields; and scheduling of individuals assigned to scout fields.

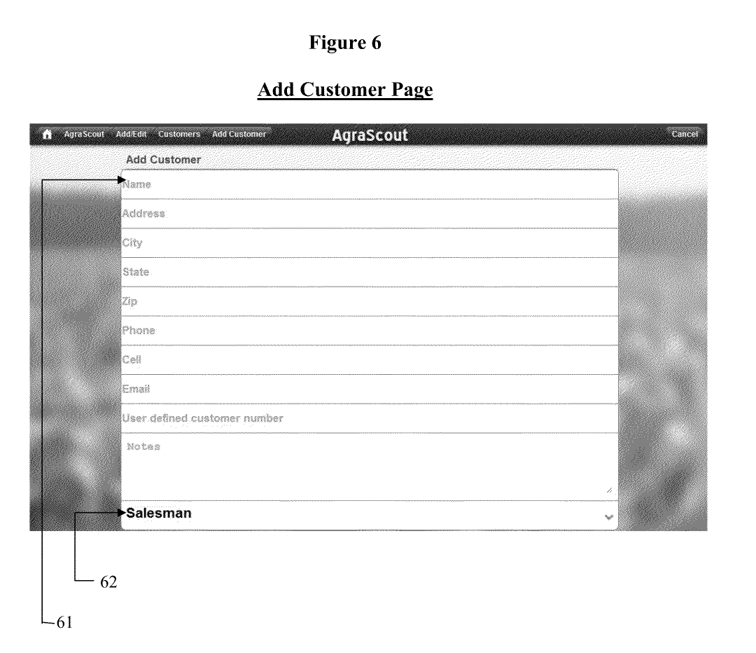

FIG. 6 is another screenshot for the GUI showing the “Add Customer Page” view. The system provides means for users to manually input a new customer's information (e.g., name, address, city, state, zip, phone, cell, email, user defined customer number, notes) into input fields 61. Additionally a user can assigns salesman to customer, by clicking the “Salesman” bar 62 shown at the bottom of the screen.

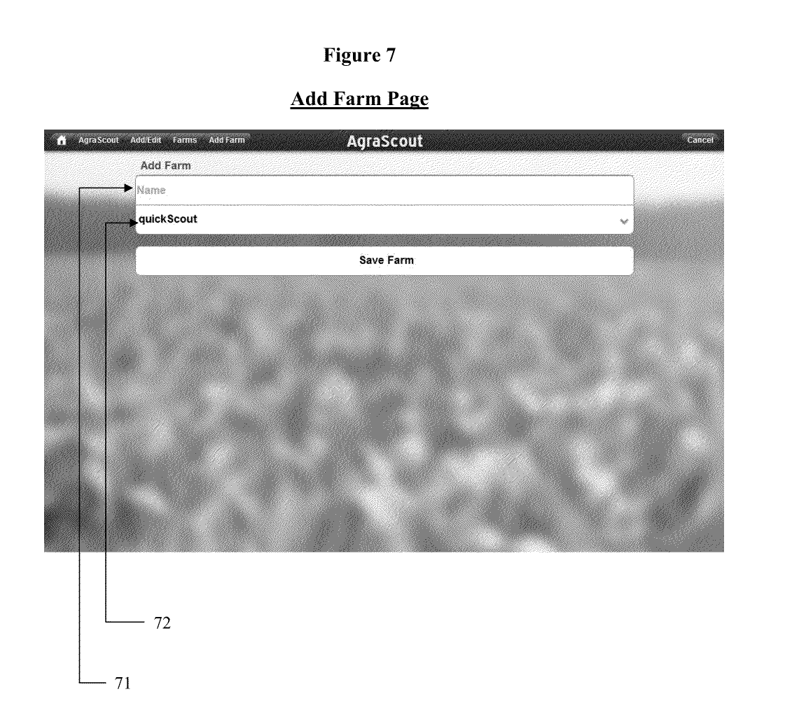

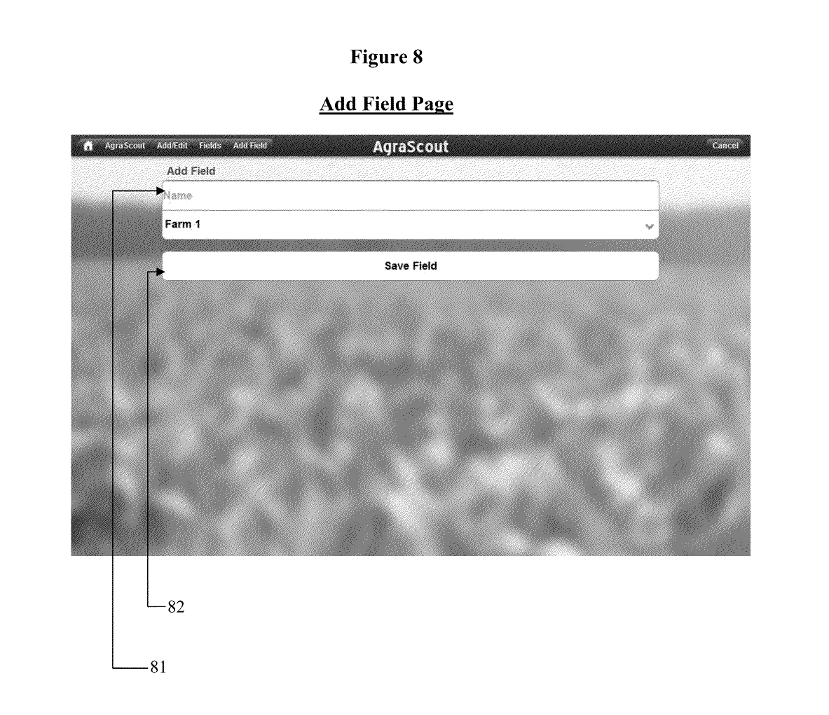

FIG. 7 shows a screenshot of the “Add Farm Page.” By typing in the input bar 71 or 72, the user can assign the name to a farm, or assign the farm name to a customer. Similarly, FIG. 8 represents a screenshot of the “Add Field Page,” where a user can type into the input bar 81 to assign field name a customer farm, and then clicks Save Field icon 82 to save such customer field name.

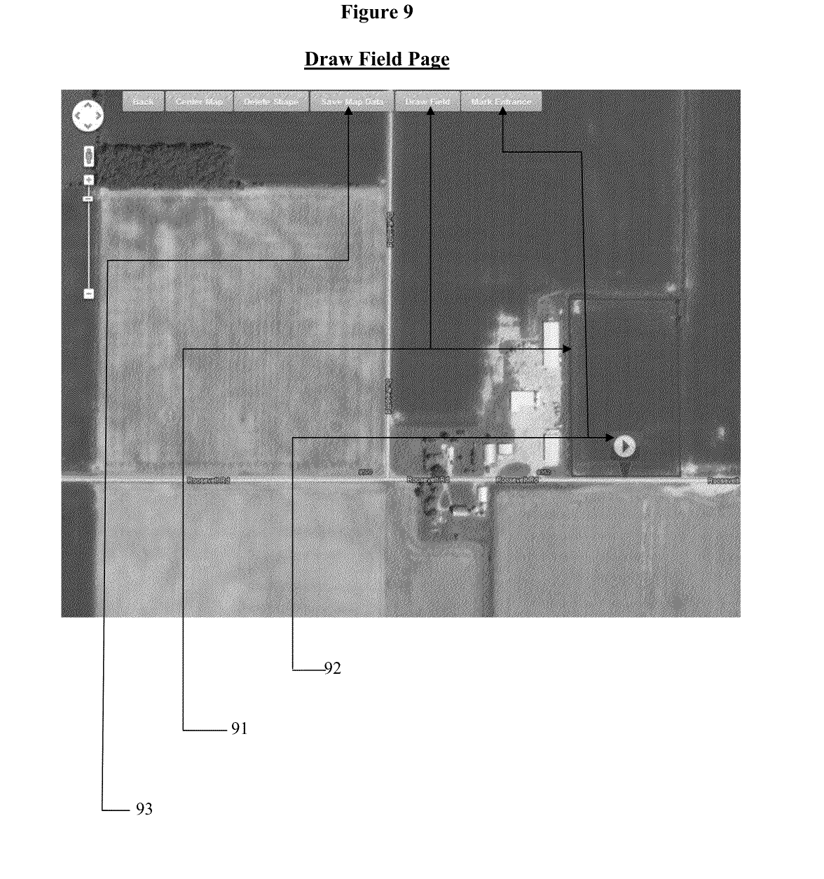

FIG. 9 is an exemplary screenshot for the GUI showing the “Draw Field Page” view, where a user can mark the farm field boundaries and mark entrance(s) to the farm field, on the geospatial map displaced on the screen. In particular, the user draws borders of the farm field by clicking “Draw Field” Icon 91 on the top of the screen, using the geospatial system provided by the present system. The “Mark Entrance” Icon 92 is also displayed on the top of the screen and the process of marking entrance(s) is disclosed before. After marking on the map, a user can click “Save Map Data” Icon 93 to save the filed map data to the customer database.

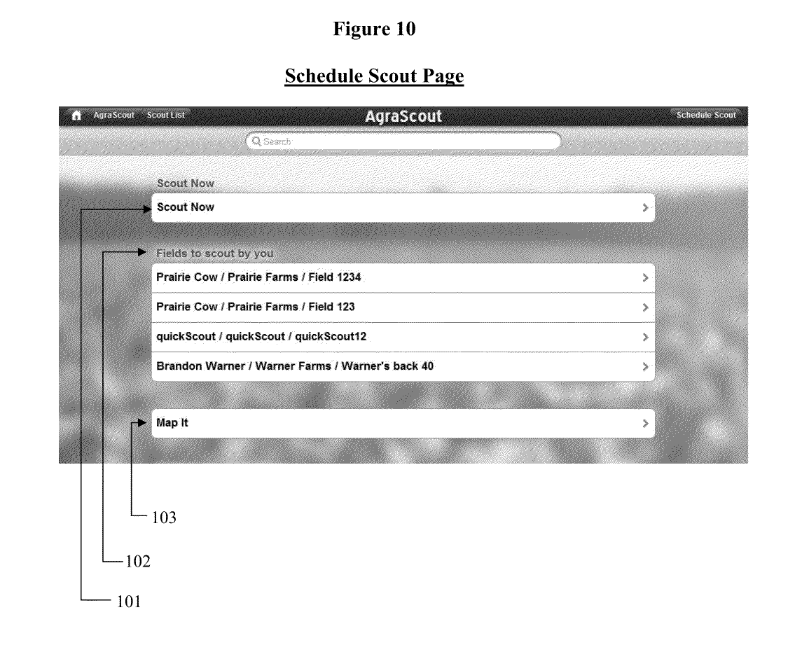

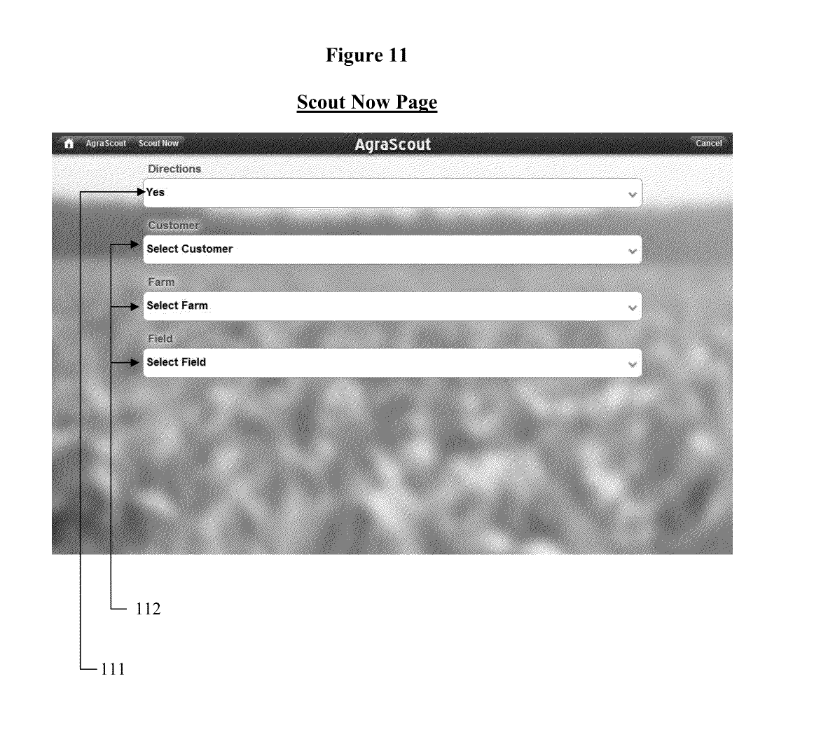

FIG. 10 shows a screenshot of the “Schedule Scout Page,” where the user can make scout schedules, with option to Scout Now. For example, “Scout Now” Icon 101 allows users to scout an unscheduled farm field; “Map It” bar 103 allows users to view all scouting jobs on an area map; and “Fields to scout by you” input fields 102 list scouting jobs for the assigned scout to complete. Further, FIG. 11 shows a screenshot of the “Scout Now Page” according to the present disclosure. This page allows user to scout customer field without a scheduled scout. As shown in the figure, “Directions”—selection bar 111—provides users with optional directions to farm field. This page also allows users to select the customer, customer's farm, and filed to scout, through the Customer/Farm/Field selection bars 112.

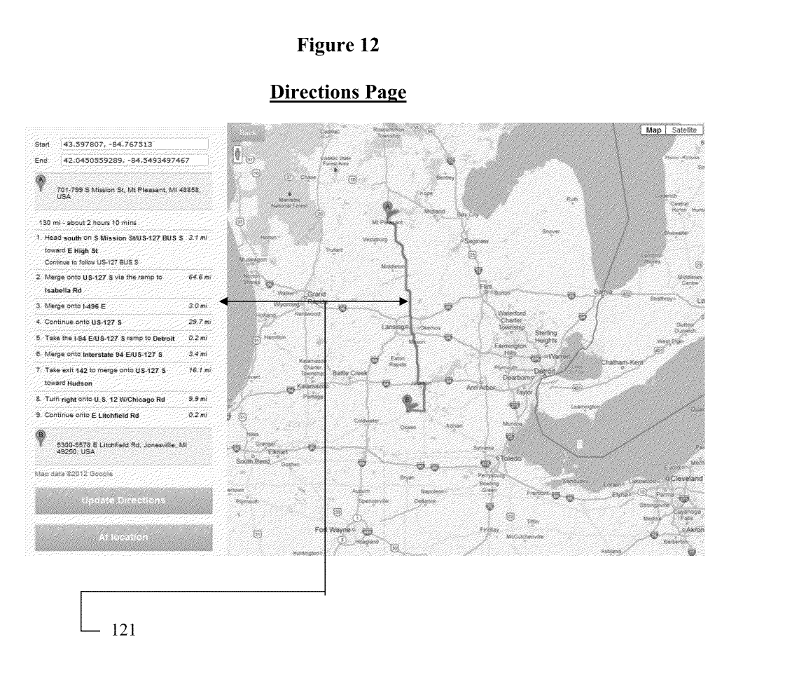

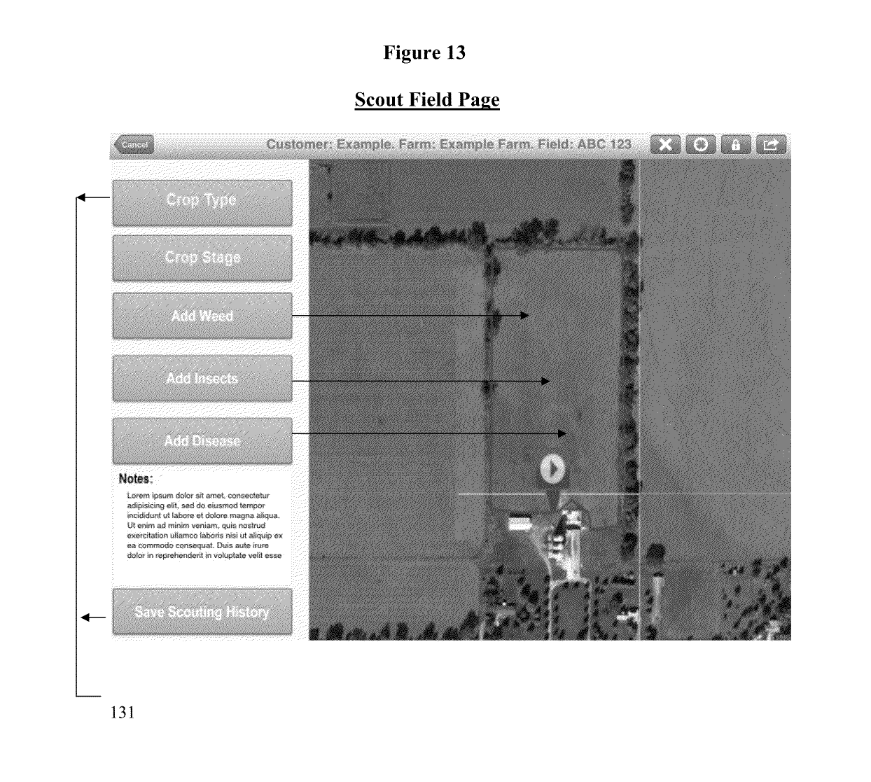

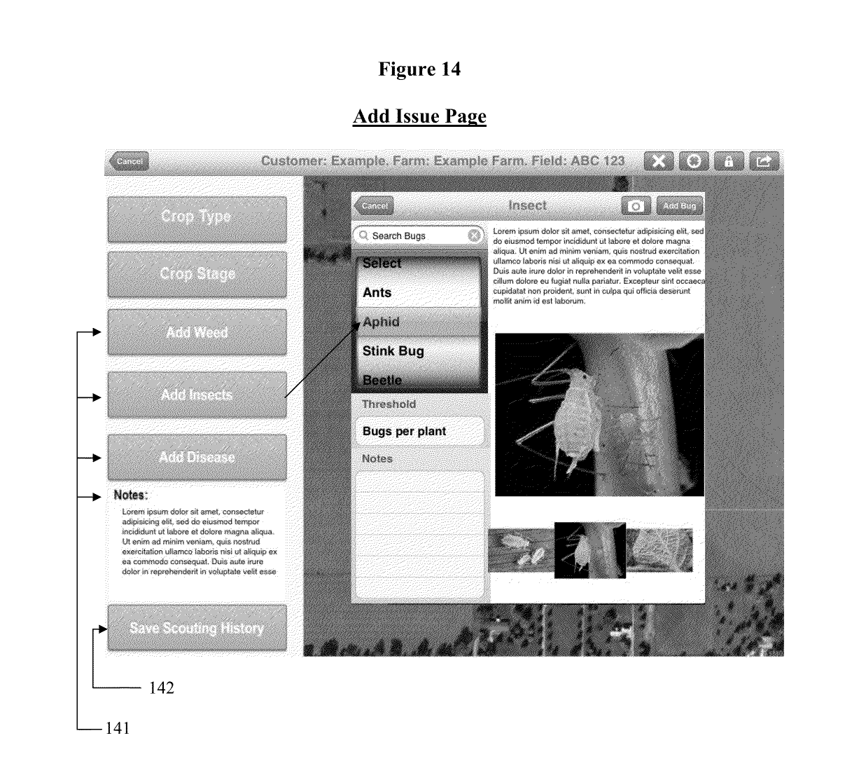

As shown in FIG. 12, a screenshot of the “Directions Page” illustrates that system can provide the turn-by-turn directions and road map 121 to entrance of the filed to be scouted. FIG. 13 is an exemplary screenshot of the “Scout Field Page/Screen,” which is used by a user to mark observations within the field boundaries. For example, there are different icons 131 (e.g., Crop Type, Crop Stage, Add Weed, Add Inspects, Add Disease, and Save Scouting History) displayed on the left hand column, and a geospatial map shown on the screen. As shown in FIG. 14, a screenshot of “Add Issue Page,” a user can add issue and view images with descriptions by selecting either Weed, Insect, Disease, or Note other condition Icon 141, as shown on the left hand column. By doing so, detailed photographs and descriptions, as shown in the central part of the screen, help the user identity and select the issue found in the farm field. A detailed description of the process for marking observations and adding issues when a user enters into the field has been disclosed before. In addition, a user can click “Save Scouting History” Icon 142 when all issues are entered for the farm field.

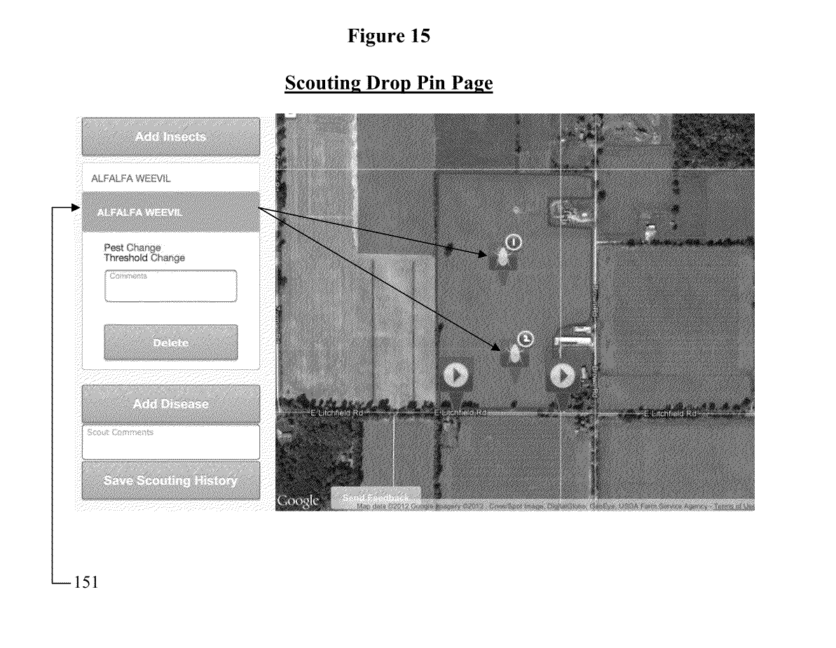

FIG. 15 is an exemplary screenshot for the GUI showing the “Scouting Drop Pin Page” view. This page has several icons—e.g., Add Insects, Add disease, Save Scouting History—on the left hand column, and a geospatial map displayed on the screen, showing the field, entrances, and numbered the dropped pins located in the field. Each dropped pin is associated with a small window 151 where the pest information can be viewed and/or edited by the user. As described before, the user can drop pins to indicate issues found in the farm field. The pins automatically locate to the users geospatial location in the farm field. The user has the ability to move the dropped pins to another location anywhere within the geospatial boundaries outlined in red on the farm field map.

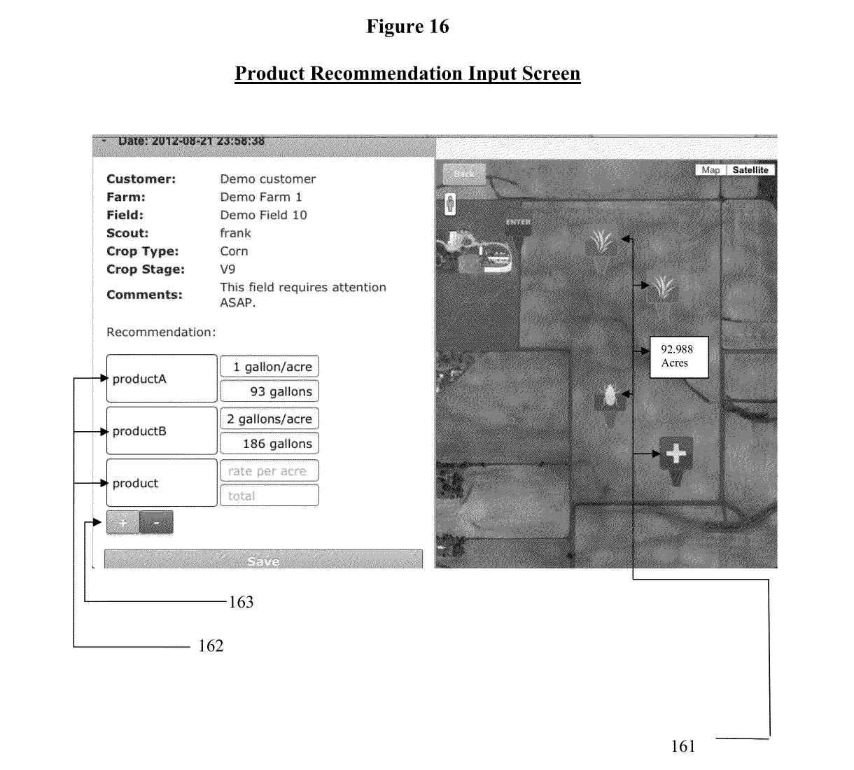

FIG. 16 shows a screenshot of the “Product Recommendation Input Screen” for the present crop scouting and pest cure recommendation system. A marked geospatial map 161 on the right sides shows the findings and severity of the findings by scouting farm field. In some embodiments, touching or hovering over the icon with the pointer will show complete scout Findings; while touching or clicking the field within the geospatial boundaries of the field will show a calculation of the total acres of the farm field. Accordingly, the left side column provides recommendations 162, which can be product recommendations, quantity per acre and total product required for a total acreage of farm field entered by sales personnel to cure findings. Sales person can add or delete as many products as necessary by icon 163.

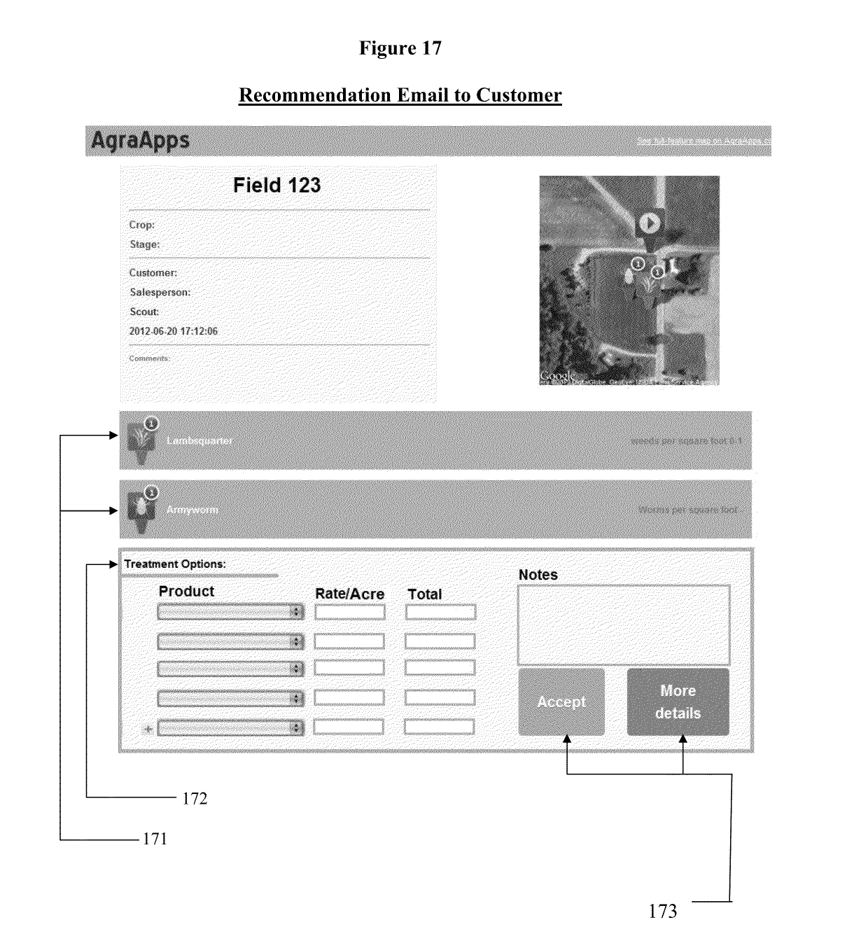

FIG. 17 is an exemplary screenshot for the GUI showing the “Recommendation Email to Customer Page” view. A detailed process for emailing the recommendation to a customer is disclosed before. In particular, this email page shows (1) information and geospatial map of the filed; (2) findings and severity of findings discovered by scouting farm field 171; (3) product recommendations to cure findings found by scouting farm field 172; and (4) choice of “Accept” and “More details” Icons 173. Customer's acceptance of product recommendations creates customer work order and delivery Ticket. Customer invoice is created automatically upon delivery to customer geo-location. More details button alerts salesperson to call customer and discuss findings.

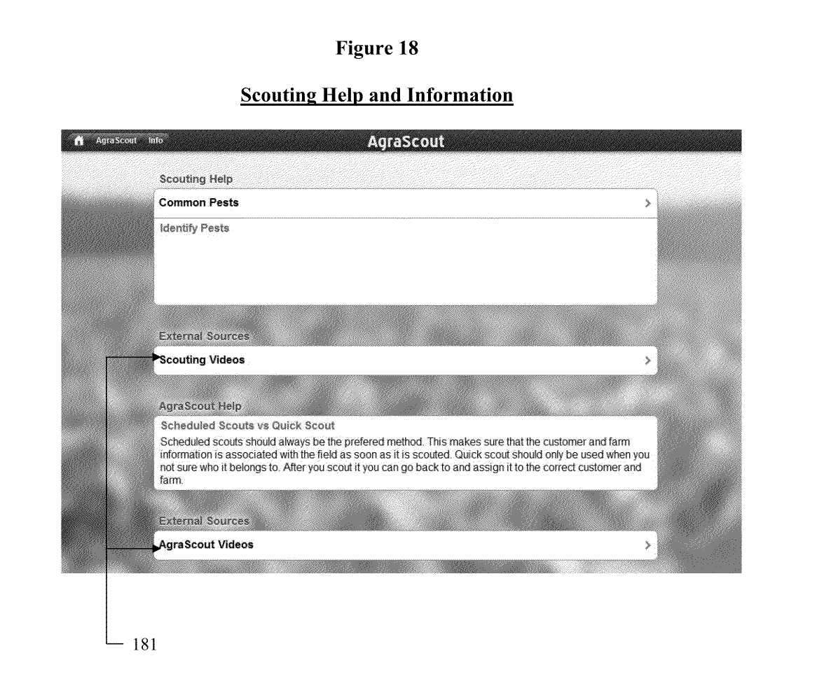

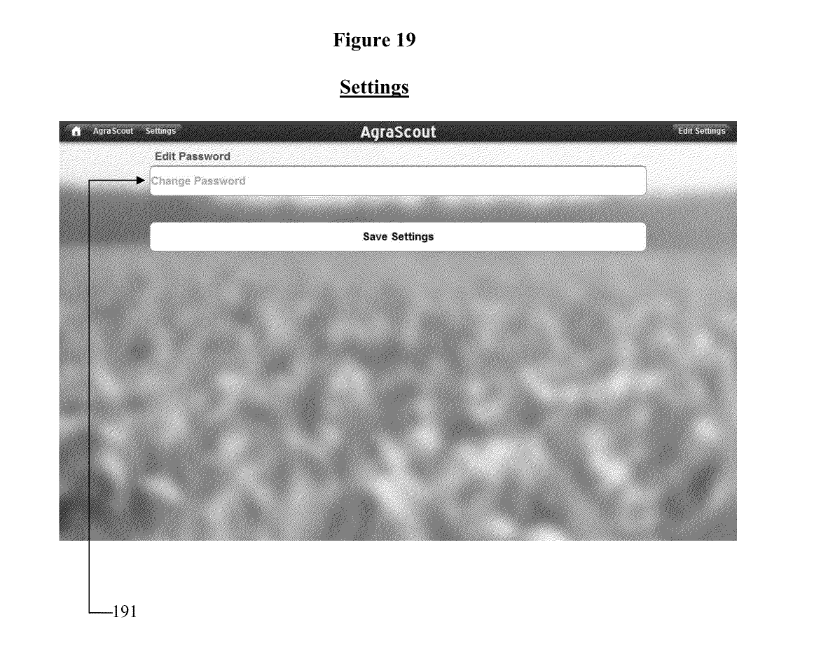

FIG. 18 presents a screenshot of the “Scouting Help and Information” view according to the disclosed system. As shown hereby, the system providing “Scouting Help” by linking to external sources 181. For example, a user can view digital photographs or videos of issues discovered by scouts. FIG. 19 shows a screenshot of “Settings” page, where the user can input and change their individual password through input fields 191.

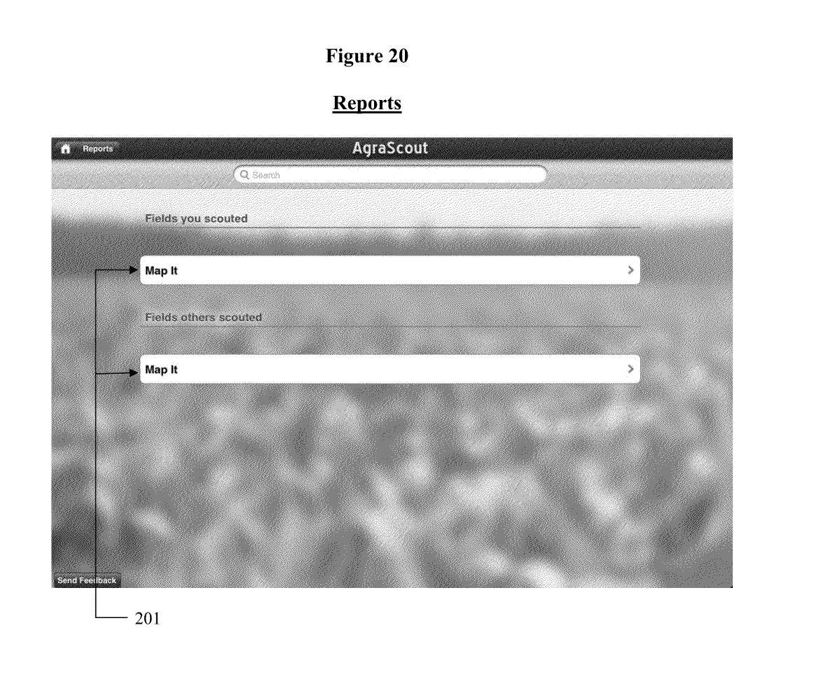

FIG. 20 is an exemplary screenshot for the GUI showing the “Report” view. Through the selection/input bar 201 as shown in the figure, the user can view or print farm field scouting reports. Information included in the scouting reports is managed by the system user. Reports can be in any order required by the system user and across all customers, Farms and Farm Fields, including, but not limited to: (1) customer, farm, farm field, crop, maturity, findings (weed, insect, disease, other), severity, treatment recommendations; (2) crop, maturity, findings (weed, insect, disease, other), severity, treatment recommendations; (3) geo-spatial region identified by system user, crop, maturity, findings (weed, insect, disease, other), severity, treatment recommendations; and (4) treatment recommendations, crop, maturity, findings (weed, insect, disease, other), severity.

This disclosure has been described as having exemplary embodiments and is intended to cover any variations, uses, or adaptations using its general principles. It is envisioned that those skilled in the art may devise various modifications and equivalents without departing from the spirit and scope of the disclosure as recited in the following claims. Further, this disclosure is intended to cover such variations from the present disclosure as come within the known or customary practice within the art to which it pertains.

1. A process for crop scouting and pest cure recommendation comprising the following steps:
identifying and marking geo-location of insects, weeds, diseases, or other remarkable conditions;
reporting findings to a customer;
providing product and application recommendations to the customer for curing remarkable conditions; and
maintaining a history file to determine trends and treatment programs,
wherein the process is executed on a portable computing device equipped with a global positioning system.

2. The process of claim 1 wherein the computing device comprises a computer, a notebook, a tablet, or a cell phone.

3. The process of claim 1 operated on a binary coded digit operating system.

4. The process of claim 1 wherein the portable computing device is equipped with a network card, and the process can be operated under a native based application or an Internet based application.

5. The process of claim 4 further comprising the following steps:
storing captured data in a temporary cache file when Internet access is unavailable, and
interrogating the cache file to update an Internet based system file when Internet access is restored.

6. The process of claim 1 further comprising one or more of the following steps:
locating, displaying, or saving a geospatial system map that includes physical boundaries of a farm field as a polynomial expression, through an input of the computing device, wherein the input is a touch screen, a keyboard, or a mouse;
importing computer shapefiles of physical boundaries of the farm field from computer based systems, wherein physical boundaries of the farm field were previously determined and saved as shapefiles;
marking an entrance to the farm field on the geospatial system map by a user;
providing turn-by-turn directions and a route map in a roadmap or satellite view;
identifying insects, weeds, diseases or other remarkable conditions by providing the user with a reference library of definitions and/or photographs of insects, weeds, diseases or other remarkable conditions;
dropping a pin and noting condition or severity on the geospatial system map showing places of insects, weeds, diseases, or other remarkable conditions;
associating the noted condition or severity with the dropped pin; and
coloring and numbering the dropped pin for further identifying the noted condition or severity.

7. The process of claim 6 wherein the computing device includes a camera and the process further comprises the following steps:
taking a digital photograph or digital video of the remarkable condition by the camera, and
associating the photograph or video with the dropped pin.

8. The process of claim 7 capable of automatic identification by a digital object recognition method and further comprising the following steps:
downloading the digital photograph taken by the camera;
comparing the digital photograph to a file of known agricultural pests or weeds; and
selecting a known agricultural pest or weed that exemplifies the characteristics of the digital photograph.

9. The process of claim 1 further comprising a step of saving a file wherein the file includes at least some of the following information: geospatial boundaries of the farm field; the entrance to the farm field; the dropped pin; and the noted condition, severity, photograph, or video associated with the dropped pin.

10. The process of claim 9 further comprising a step of editing or reporting previously saved information, wherein the edited or reported information includes some of the following information: geospatial boundaries of the farm field; the entrance to the farm field; the dropped pin; and the noted condition, severity, photograph, or video associated with the dropped pin.

11. The process of claim 10 wherein the reported information further comprises recommendations for curing remarkable conditions.

12. The process of any of claims 10 wherein the report is transferred to the customer by an email, text, facsimile, telephone, voice mail, social media, push notification, or printed hard copy.

13. The process of claim 1 wherein the history file comprises some of the following information: the noted condition by crop scouting, recommendations for curing remarkable conditions, and effectiveness of the treatment programs following the recommendations.

14. The process of claim 1 further comprising a step of accessing automatically the information of the customer or the farm field, when the user is within a pre-specified distance from the farm field.

15. The process of claim 1 further comprising the steps of booking or completing a work order; and automatically preparing and sending a customer invoice at the completion of the customer work order.

16. A system for croup scouting and pest cure recommendation comprising
a geo-location module for identifying and making geo-location of insects, weeds, diseases, or other remarkable conditions;
a reporting module for reporting findings to a customer;
a recommendation module for providing product and application recommendations for curing remarkable conditions to the customer; and
a history module for maintaining a history file to determine trends and treatment programs,
wherein the system is implemented on a portable computing device equipped with a global positioning system module.

17. The system of claim 16 wherein the portable computing device comprises a computer, a notebook, a tablet, or a cell phone.

18. The system of claim 17 wherein the portable computing device is equipped with a network card and the system can be operated under a native based application or an Internet based application.

19. The system of claim 18 that is capable of
storing captured data in a temporary cache file when Internet is unavailable; and
interrogating the temporary cache file and updating an Internet based system file when Internet is restored.

20. The system of claim 16 further comprising a graphic user interface, which allows a user to enter data, command, selection, or response into the system by a user input device, and to review output information by a display device.

21. The system of claim 20 wherein the user input device comprises a touch screen, a keyboard, or a mouse.

22. The system of claim 20, wherein the display device comprises a screen or a printer.

23. The system of claim 21 including a camera and capable of taking and receiving a digital photograph or digital video of remarkable conditions.

24. The system of claim 20 wherein the geo-location module comprises one or more of the following means:
means to locate, save, and transfer to the display device a geospatial system map that includes physical boundaries of a farm field as a polynomial expression, through the user input device;
means to import computer shapefiles of physical boundaries of the farm field from computer based systems, wherein the physical boundaries of the farm field were previously determined and saved as shapefiles;
means to mark an entrance to the farm field on the geospatial system map by the user;
means to provide turn-by-turn directions and a route map in a roadmap or satellite view;
means to automatically access the data of the customer or the farm field, when the user is within a pre-specified distance from the farm field;
means to identify insects, weeds, diseases or other remarkable conditions by providing the user with a reference library of definitions and/or photographs of insects, weeds, diseases or other remarkable conditions;
means to drop a pin and note condition or severity on the geospatial map showing the place of insects, weeds, diseases, or other remarkable conditions;
means to associate the noted condition or severity with the dropped pin; and
means to color and number the dropped pin for further identifying the noted condition or severity.

25. The system of 23 wherein the geo-location module comprises
means to take the digital photograph or digital video of remarkable conditions, and
means to associate the photograph or video with the dropped pin.

26. The system of 23 wherein the geo-location module is capable of automatic identification by a digital object recognition method and comprises:
means to download the digital photograph taken by the camera;
means to compare the digital photograph to a file of known agricultural pests or weeds; and
means to select a known agricultural pest or weed that exemplifies the characteristics of the digital photograph.

27. The system of claim 20 wherein the reporting module comprises means to create, edit, or save a report from previously saved information by the graphic user interface, wherein the report comprises at least some of the following information: geospatial boundaries of the farm field; the entrance to the farm field, the noted condition and severity associated with the dropped pin, the photograph or video associated with the dropped pin, and recommendations for curing remarkable conditions.

28. The system of claim 27 wherein the report can be transferred to the customer by an email, text, facsimile, telephone, voice mail, social media, push notification, or printed hard copy.

29. The system of claim 20 wherein the reporting module comprises means to book a work order, and to automatically prepare and send a customer invoice at the completion of the work order.

30. The system of claim 20 wherein the recommendation module comprises means to create, edit, or save recommendations for curing remarkable conditions.

31. The system of claim 20, wherein the history module comprises means to maintain the history file for the noted condition by crop scouting, recommendations for curing remarkable conditions, and effectiveness of the treatment programs following the recommendations.
